(19) United States
(12) Patent Application Publication
(10) Pub. No.: US 2018/0216587 A1
(43) Pub. Date: Aug. 2, 2018

(54) FUEL PIPE STRUCTURE

(71) Applicant: Toyota Jidosha Kabushiki Kaisha, Toyota-shi Aichi-ken (JP)

(72) Inventor: Junpei Morimoto, Toyota-shi Aichi-ken (JP)

(73) Assignee: Toyota Jidosha Kabushiki Kaisha, Toyota-shi Aichi-ken (JP)

(21) Appl. No.: 15/882,021

(22) Filed: Jan. 29, 2018

(30) Foreign Application Priority Data
Feb. 1, 2017 (JP) 2017-016884

(51) Int. Cl. F02M 37/00; F02M 55/04; B60K 15/01; F16L 3/13; F16L 55/035; F16L 25/10

(52) U.S. Cl. CPC F02M 37/0017; F02M 55/04; F02M 37/0047; F16L 25/10; F16L 3/13; F16L 55/035; B60K 15/01

(57) ABSTRACT

A fuel pipe structure includes a fuel pipe through which fuel is supplied from a fuel tank to an internal combustion engine, the fuel pipe including a first pipe connected to the internal combustion engine and a second pipe connected to the first pipe, a supporting portion to which the second pipe is attached, and a fixation portion configured to fix the supporting portion to a vehicle. An end portion of the second pipe that is on the first pipe side is attached to the supporting portion.

### CROSS-REFERENCE TO RELATED APPLICATIONS

This application claims priority to Japanese Patent Application No. 2017-016884 filed on Feb. 1, 2017, which is incorporated herein by reference in its entirety including the specification, drawings and abstract.

### BACKGROUND

### 1. Technical Field

The present disclosure relates to a fuel pipe structure.

### 2. Description of Related Art

Japanese Unexamined Patent Application Publication No. 2002-106438 (JP 2002-106438 A) discloses a fuel pipe structure that supplies fuel from a fuel tank to an internal combustion engine. The fuel pipe is configured of a plurality of pipes and includes a first pipe of which a first end is connected to a fuel delivery pipe of the internal combustion engine and a second pipe that is connected to a second end of the first pipe. In the fuel pipe structure described in JP 2002-106438 A, a clip to which the second pipe is attached is provided and the second pipe is supported on a vehicle body by means of the clip.

### SUMMARY

The fuel pipe is connected to the internal combustion engine. Therefore, the fuel pipe vibrates as the internal combustion engine vibrates. When the fuel pipe vibrates, other members disposed in the vicinity of the fuel pipe and the fuel pipe may interfere with each other. In a case where the other members are formed of material that is harder than that of the fuel pipe, the fuel pipe may be damaged when the fuel pipe interferes with the other components. The fuel pipe structure described in JP 2002-106438 A has been designed without considering the interference between the fuel pipe and the other members that occurs due to vibration of the fuel pipe and thus there is room for improvement.

An aspect relates to a fuel pipe structure including a fuel pipe, a supporting portion, and a fixation portion. The fuel pipe includes a first pipe connected to an internal combustion engine and a second pipe connected to the first pipe and fuel is supplied from a fuel tank to the internal combustion engine through the fuel pipe. The second pipe is attached to the supporting portion. The fixation portion is configured to fix the supporting portion to a vehicle. An end portion of the second pipe that is on the first pipe side is attached to the supporting portion.

Vibration of the internal combustion engine is transmitted to the second pipe via the first pipe. When the second pipe oscillates due to the vibration of the internal combustion engine, the magnitude of vibration of the first pipe also increases. According to the aspect, the end portion of the second pipe that is on the first pipe side is supported by the supporting portion. Accordingly, even when the vibration of the internal combustion engine is transmitted, oscillation of the second pipe on the first pipe side is more appropriately suppressed. Therefore, an increase in magnitude of the vibration of the first pipe that occurs when the vibration of the internal combustion engine is transmitted is more appropriately suppressed and thus it is possible to further suppress vibration of the fuel pipe. As a result, with the configuration described above, it is possible to more appropriately suppress interference between a member other than the fuel pipe that is disposed in the vicinity of the fuel pipe and the fuel pipe.

In the fuel pipe structure according to the aspect, the second pipe may include a base end portion that is connected to the end portion and that is positioned closer to the fuel tank side than the end portion. The supporting portion may include a first supporting portion to which the end portion of the second pipe is attached, a second supporting portion to which the base end portion of the second pipe is attached, and a connection wall that connects the first supporting portion and the second supporting portion to each other.

According to the aspect, the end portion of the second pipe is supported by the first supporting portion and the base end portion of the second pipe is supported by the second supporting portion. In addition, the first supporting portion and the second supporting portion are connected to each other by the connection wall. Therefore, it is possible to support both of the end portion and the base end portion of the second pipe. Accordingly, it is possible to further improve the supporting properties with respect to the second pipe. In addition, it is possible to commonize connection between the first supporting portion, the second supporting portion, and the fixation portion when fixing the supporting portion with the improved supporting properties with respect to the second pipe, which results in a contribution to a decrease in the number of components.

In the fuel pipe structure according to the aspect, the second pipe may include a base end portion that is connected to the end portion and that is positioned closer to the fuel tank side than the end portion. The supporting portion may include a first supporting portion to which the end portion of the second pipe is attached.

In the fuel pipe structure according to the aspect, the fixation portion may be connected to the first supporting portion.

In the fuel pipe structure according to the aspect, the supporting portion may further include a second supporting portion to which the base end portion of the second pipe is attached.

In the fuel pipe structure according to the aspect, the fixation portion may be connected to the first supporting portion and the second supporting portion.

In the fuel pipe structure according to the aspect, the fixation portion may be connected to the second supporting portion. According to the aspect, the second supporting portion that supports the base end portion of the second pipe is fixed to the vehicle via the fixation portion. Therefore, it is not needed to provide a fixation portion that is connected to the first supporting portion and thus a space in the vicinity of the first supporting portion that supports the end portion of the second pipe is not occupied by the fixation portion. Accordingly, it is possible to appropriately restrain the space in the vicinity of the first supporting portion from becoming narrow. Therefore, with the configuration described above, it is possible to further improve the assembling workability of the second pipe with respect to the first supporting portion.

In the fuel pipe structure according to the aspect, the connection wall may include a recess provided on a wall surface of the connection wall that is on the second pipe side, and the recess may come into contact with the second pipe. According to the aspect, the second pipe comes into contact with the recess on the connection wall. Therefore, it is possible to more appropriately suppress vibration of the second pipe.

In the fuel pipe structure according to the aspect, each of the first supporting portion and the second supporting portion may include a facing wall that faces the second pipe and a pair of retaining walls that protrudes from opposite end portions of the facing wall, each of the retaining walls including an abutting portion that abuts onto one half of a circumferential portion of the second pipe that is on a side opposite to the facing wall side in a state where the second pipe abuts onto the facing wall. The connection wall may be connected to the facing wall of the first supporting portion and the facing wall of the second supporting portion.

According to the aspect, the connection wall is connected to the facing wall of the first supporting portion and the facing wall of the second supporting portion. In addition, the second pipe is pressed to reach the facing wall with the retaining walls being elastically deformed and the space between the abutting portions being expanded such that the second pipe is attached to the first and second supporting portions. With the configuration described above, the connection wall is not likely to inhibit elastic deformation of each retaining wall and thus it is possible to more appropriately suppress deterioration in attachment property of the second pipe with respect to the first and second supporting portions that is caused by the connection to the connection wall.

The fuel pipe structure according to the aspect may further include a connection pipe configured to connect an upstream side end of the first pipe and a downstream side end of the second pipe to each other.

In the fuel pipe structure according to the aspect, the connection pipe may include a first internal pipe portion that is inserted into the first pipe, a second internal pipe portion that is inserted into the second pipe, and a stopping pipe portion that is disposed between the first internal pipe portion and the second internal pipe portion. The outer diameter of the stopping pipe portion may be larger than the outer diameter of the first internal pipe portion and the outer diameter of the second internal pipe portion, the stopping pipe portion including a downstream side surface onto which the upstream side end of the first pipe abuts and an upstream side surface onto which the downstream side end of the second pipe abuts.

In the fuel pipe structure according to the aspect, the facing wall of the supporting portion may include a recess that accommodates a portion of the second pipe and onto which the second pipe abuts.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a schematic view of a vehicle to which a first embodiment of a fuel pipe structure is applied;

FIG. 2 is a side view illustrating the fuel pipe structure;

FIG. 3 is a perspective view of the fuel pipe structure as seen from a vehicle rear side;

FIG. 4 is a sectional view of a fuel pipe;

FIG. 5 is a sectional view illustrating a state before a first pipe and a second pipe are connected to each other;

FIG. 6 is an enlarged side view illustrating the fuel pipe structure;

FIG. 7 is a sectional view taken along line VII-VII in FIG. 6;

FIG. 8 is a sectional view illustrating a state before a first supporting portion and the second pipe are assembled with each other;

FIG. 9 is a sectional view illustrating a state where the first supporting portion and the second pipe are assembled with each other;

FIG. 10 is a sectional view taken along line X-X in FIG. 6;

FIG. 11 is a side view illustrating a state before a fixation portion and a supporting clamp are assembled with each other;

FIG. 12 is a side view illustrating a state where the fixation portion and the supporting clamp are assembled with each other;

FIG. 13 is a sectional view illustrating a modification example of the first supporting portion;

FIG. 14 is a sectional view illustrating a state where the second pipe is being assembled with the first supporting portion in the modification example of the first supporting portion;

FIG. 15 is a side view illustrating a modification example of the fuel pipe structure; and

FIG. 16 is a side view illustrating another modification example of the fuel pipe structure.

### DETAILED DESCRIPTION OF EMBODIMENTS

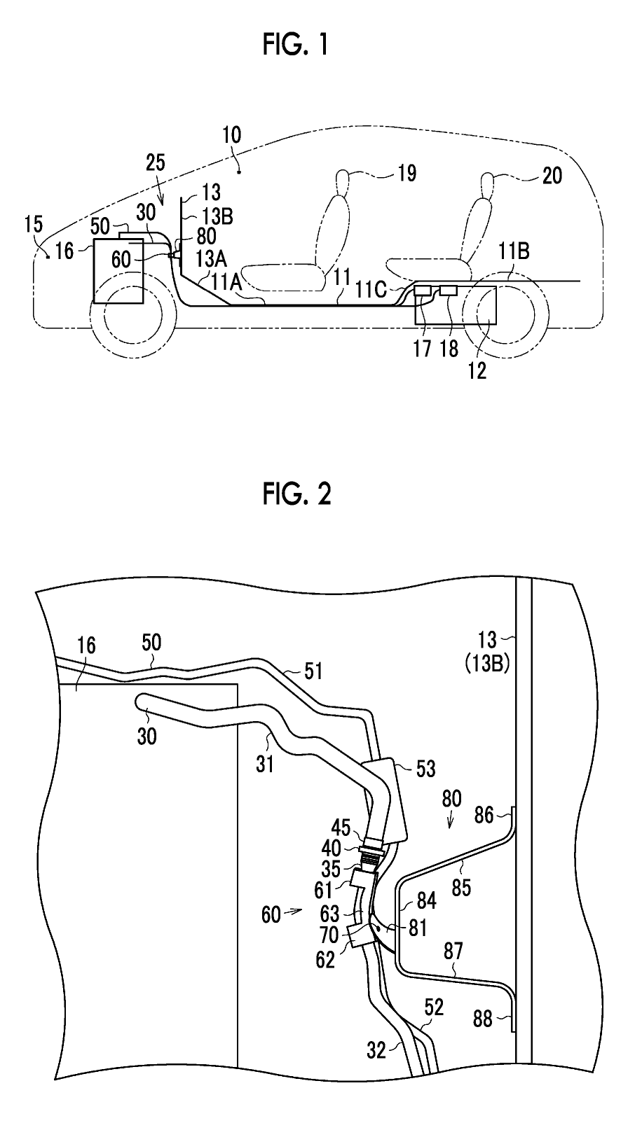

An embodiment of a fuel pipe structure will be described with reference to FIGS. 1 to 12. In the embodiment, a supporting structure of a purge pipe as a fuel pipe will be described as an example. As illustrated in FIG. 1, a vehicle is provided with a floor panel 11 that constitutes the floor of a vehicle cabin 10. The floor panel 11 extends in a vehicle front-rear direction (right-left direction in FIG. 1) and includes a front portion 11A that is disposed below a driver's seat 19 and a rear portion 11B that is disposed below a backseat 20. The rear portion 11B is disposed above the front portion 11A in a vehicle height direction. The rear end of the front portion 11A and the front end of the rear portion 11B are connected to each other via an intermediate portion 11C. The intermediate portion 11C is disposed to become closer to the vehicle upper side toward a vehicle rear side. In the vehicle, a fuel tank 12 is installed below the rear portion 11B of the floor panel 11.

In addition, the vehicle is provided with a dash panel 13 that is connected to the front end of the floor panel 11. The dash panel 13 is configured of a forward extending portion 13A that extends from the floor panel 11 to a vehicle front side in an obliquely upward direction and an upward extending portion 13B that extends from the front end of the forward extending portion 13A to the vehicle upper side. The dash panel 13 separates the vehicle cabin 10 and an engine compartment 15 from each other in the vehicle front-rear direction.

The dash panel 13 is one of the constituent members of the vehicle.

The engine compartment 15 accommodates an internal combustion engine 16. A fuel pipe 25 is connected to the internal combustion engine 16. The fuel pipe 25 is a pipe through which fuel is supplied from the fuel tank 12 to the internal combustion engine 16 and is configured of a purge pipe 30 and a fuel supply pipe 50.

A first end portion of the purge pipe 30 passes through a side portion of the internal combustion engine 16 and is connected to an intake system (for example, intake manifold) of the internal combustion engine 16. In addition, the purge pipe 30 is routed toward the vehicle rear side and a second end portion of the purge pipe 30 is connected to a canister 17. The canister 17 and an upper portion of the fuel tank 12 communicate with each other via a communication pipe (not shown) and evaporated fuel generated in the fuel tank 12 is supplied to the canister 17 to be stored in the canister 17. For example, when the amount of evaporated fuel stored in the canister 17 becomes equal to or larger than a predetermined amount, a negative pressure is supplied to the purge pipe 30 from the intake system of the internal combustion engine 16, so that the evaporated fuel is supplied to the internal combustion engine 16.

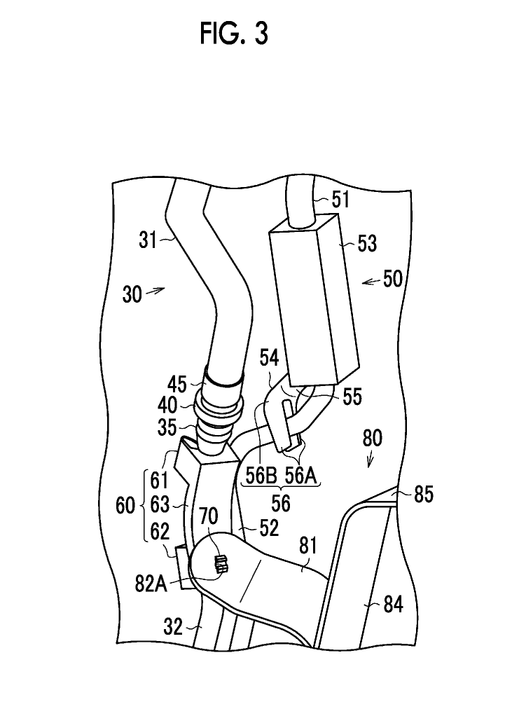

As illustrated in FIGS. 2 and 3, the purge pipe 30 is configured to include a cylindrical first pipe 31 that is connected to the internal combustion engine 16 and a cylindrical second pipe 32 that is connected to the first pipe 31. The first pipe 31 is formed of rubber and the second pipe 32 is formed of thermosetting resin. The evaporated fuel from the fuel tank 12 is supplied to the internal combustion engine 16 while passing through the second pipe 32 and the first pipe 31 in sequence. Hereinafter, the fuel tank 12 side will be referred to as an upstream side in an evaporated fuel flowing direction (hereinafter, simply referred to as “upstream side”) and the internal combustion engine 16 side will be referred to as a downstream side in the evaporated fuel flowing direction (hereinafter, simply referred to as “downstream side”). The purge pipe 30 also includes a connection pipe 40 that connects an upstream side end of the first pipe 31 and a downstream side end of the second pipe 32 to each other. The connection pipe 40 has a cylindrical shape and is formed of heat resistant resin.

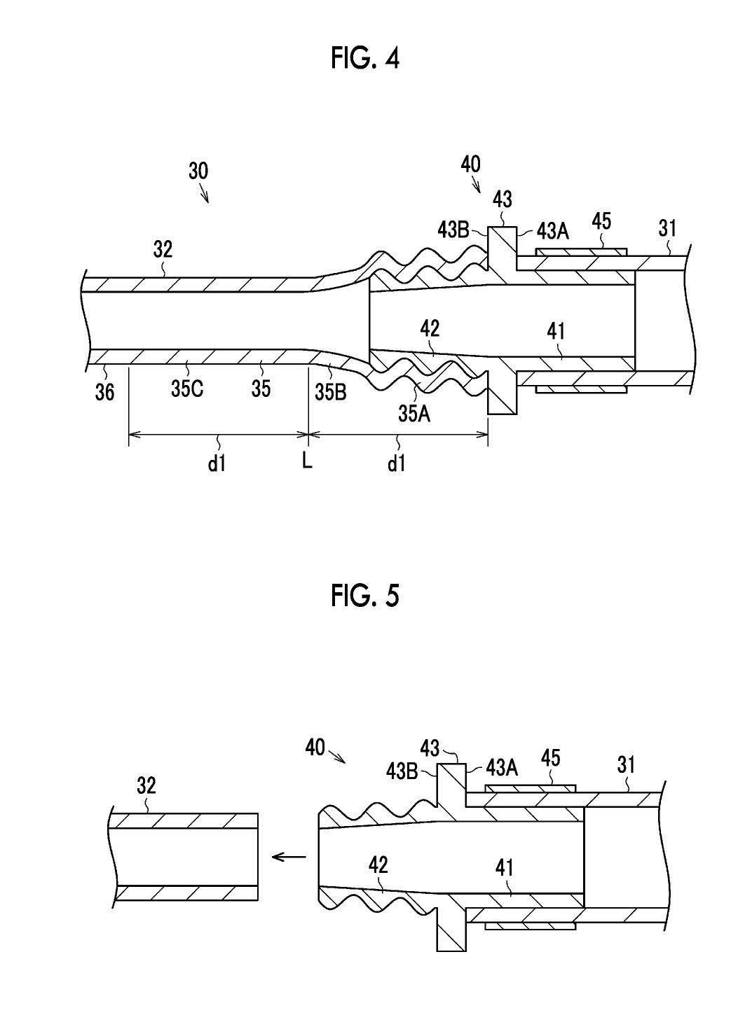

As illustrated in FIG. 4, the connection pipe 40 is configured of a first internal pipe portion 41 that is inserted into the first pipe 31, a second internal pipe portion 42 that is inserted into the second pipe 32, and a stopping pipe portion 43 that is disposed between the first internal pipe portion 41 and the second internal pipe portion 42. The outer diameter of the first internal pipe portion 41 is substantially the same as the inner diameter of the first pipe 31. Therefore, the outer circumferential surface of the first internal pipe portion 41 comes into contact with the inner circumferential surface of the first pipe 31 over the whole circumference in a circumferential direction. The entire portion of the first internal pipe portion 41 in a direction in which the first internal pipe portion 41 extends (right-left direction in FIG. 4) is disposed in the first pipe 31. The outer circumferential surface of the first pipe 31 is provided with an annular clamping tool 45. The clamping tool 45 clamps an outer circumferential side of the first pipe 31 such that the distance between the first pipe 31 and the first internal pipe portion 41 is further decreased.

The second internal pipe portion 42 is formed to have a tapered shape, of which the diameter decreases toward the upstream side (left side in FIG. 4), as a whole. The shape of the outer surface of the second internal pipe portion 42 is a wave-shape in a sectional view illustrated in FIG. 4. The entire portion of the second internal pipe portion 42 in a direction in which the second internal pipe portion 42 extends (right-left direction in FIG. 4) is disposed in the second pipe 32. The stopping pipe portion 43 is formed to have an annular shape and the inside of the stopping pipe portion 43 communicates with the first internal pipe portion 41 and the second internal pipe portion 42. The outer diameter of the stopping pipe portion 43 is larger than the outer diameter of the first internal pipe portion 41 and the outer diameter of the second internal pipe portion 42. Therefore, the stopping pipe portion 43 includes a downstream side surface 43A that extends in a radial direction and that is disposed on the first pipe 31 side and an upstream side surface 43B that extends in the radial direction and that is disposed on the second pipe 32 side. In addition, the outer diameter of the stopping pipe portion 43 is larger than the outer diameter of the first pipe 31 and the outer diameter of the second pipe 32. The upstream side end of the first pipe 31 abuts onto the downstream side surface 43A of the stopping pipe portion 43 and the downstream side end of the second pipe 32 abuts onto the upstream side surface 43B of the stopping pipe portion 43.

An example of the way in which the first pipe 31 and the second pipe 32 are connected to each other will be described. As illustrated in FIG. 5, when the first pipe 31 and the second pipe 32 are connected to each other, first, the connection pipe 40 is attached to the first pipe 31. That is, the first internal pipe portion 41 is inserted into the first pipe 31 until the upstream side end of the first pipe 31 abuts onto the downstream side surface 43A of the stopping pipe portion 43 of the connection pipe 40. Thereafter, the first pipe 31 is clamped by the clamping tool 45 while being pressed against the first internal pipe portion 41 and thus the connection pipe 40 is attached to the first pipe 31.

Before the connection pipe 40 is attached to the second pipe 32, the second pipe 32 has a cylindrical shape of which the diameter is uniform in a direction in which the second pipe 32 extends (right-left direction in FIG. 5). In addition, the outer diameter of the second pipe 32 is smaller than the outer diameter of the first pipe 31. The outer diameter of a projecting portion on the wave-shaped outer circumferential surface of the second internal pipe portion 42 of the connection pipe 40 is larger than the outer diameter of the second pipe 32. When the second internal pipe portion 42 of the connection pipe 40 is inserted into the downstream side end of the second pipe 32 as represented with an arrow in FIG. 5, the diameter of the downstream side end portion of the second pipe 32 is increased by the second internal pipe portion 42. The second internal pipe portion 42 is inserted into the second pipe 32 until the downstream side end of the second pipe 32 abuts onto the upstream side surface 43B of the stopping pipe portion 43 of the connection pipe 40. As a result, the downstream side end portion of the second pipe 32 is deformed such that the downstream side end portion of the second pipe 32 has a shape along the shape of the outer surface of the second internal pipe portion 42 as illustrated in FIG. 4.

As described above, an end portion 35 of the second pipe 32 that is on the first pipe 31 side is configured of a wave-shaped portion 35A into which the second internal pipe portion 42 is inserted, a tapered portion 35B that is connected to the wave-shaped portion 35A and of which the diameter decreases toward the upstream side, and a tubular portion 35C that extends toward the upstream side from the tapered portion 35B. The tubular portion 35C extends by the same length as an axial distance dl from a boundary L between the tubular portion 35C and the tapered portion 35B to the downstream side end of the second pipe 32. That is, the axial length of the end portion 35 of the second pipe 32 is twice the distance dl. In addition, a portion of the second pipe 32 that is connected to the tubular portion 35C and is positioned closer to the fuel tank 12 side (left side in FIG. 4) than the end portion 35 of the second pipe 32 will be referred to as a base end portion 36. When heat is applied in a state where the second internal pipe portion 42 is inserted into the second pipe 32 such that the second pipe 32 is cured, the outer circumferential surface of the second internal pipe portion 42 is locked on the inner circumferential surface of the wave-shaped portion 35A and the connection pipe 40 is attached to the second pipe 32.

In addition, as illustrated in FIG. 1, a first end portion of the fuel supply pipe 50 passes through an upper portion of the internal combustion engine 16 and is connected to a fuel supply system (for example, fuel delivery pipe) of the internal combustion engine 16. In addition, a second end portion of the fuel supply pipe 50 is routed toward the vehicle rear side and is connected to a fuel pump 18 that is connected to the fuel tank 12. The fuel pump 18 pumps up the fuel in the fuel tank 12 such that the fuel is discharged to the fuel supply pipe 50. In this manner, the fuel in the fuel tank 12 flows through the fuel supply pipe 50 and is supplied to the internal combustion engine 16.

As illustrated in FIGS. 2 and 3, the fuel supply pipe 50 is configured to include a first fuel supply pipe 51 that is connected to the internal combustion engine 16 and a second fuel supply pipe 52 that is connected to the first fuel supply pipe 51. The first fuel supply pipe 51 and the second fuel supply pipe 52 are connected to each other via a connector (not shown) having the same configuration as that of the connection pipe 40. A cover 53 that covers the connector is attached to the fuel supply pipe 50. The cover 53 is formed of resin and is formed to have a quadrangular box-shape. As illustrated in FIG. 3, a posture maintaining tool 54 is connected to the lower end portion of the cover 53. The posture maintaining tool 54 includes a columnar spindle 55 that extends from a side wall of the cover 53. The spindle 55 is connected to a supporting body 56. The supporting body 56 is configured of a pair of supporting pieces 56A and a connecting portion 56B. The second fuel supply pipe 52 is interposed between the supporting pieces 56A and the connecting portion 56B connects one end portion of the supporting pieces 56A. The supporting pieces 56A include facing surfaces that face each other and each facing surface abuts onto the second fuel supply pipe 52. The posture maintaining tool 54 clamps the second fuel supply pipe 52 at a position below the cover 53 such that rotation of the cover 53 relative to the second fuel supply pipe 52 is more appropriately suppressed. In this manner, the cover 53, that is, the posture of a connection portion between the first fuel supply pipe 51 and the second fuel supply pipe 52 is maintained and the disposition of the first fuel supply pipe 51 and the second fuel supply pipe 52 is properly maintained.

As illustrated in FIGS. 2 and 3, the purge pipe 30 and the fuel supply pipe 50 are routed in a state of being close to each other in the engine compartment 15. Therefore, the first pipe 31 and the connection pipe 40 of the purge pipe 30 are disposed in a state of being close to a side portion of the cover 53 of the fuel supply pipe 50.

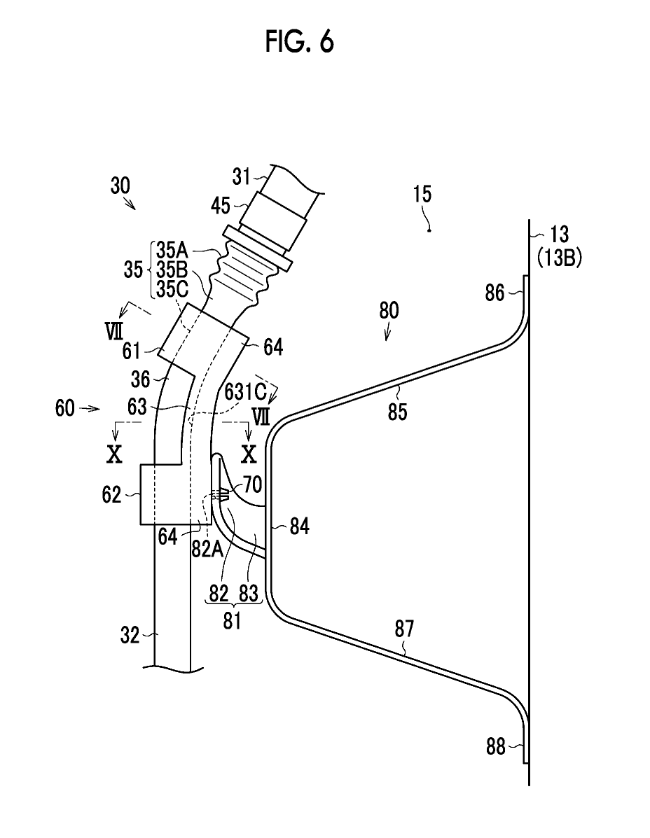

As illustrated in FIG. 6, the fuel pipe structure is disposed in the engine compartment 15 and includes a supporting clamp 60 that is attached to the second pipe 32 of the purge pipe 30 and a fixation portion 80 that fixes the supporting clamp 60 to the dash panel 13. The supporting clamp 60 is configured of a first supporting portion 61 to which the end portion 35 of the second pipe 32 is attached, a second supporting portion 62 to which the base end portion 36 of the second pipe 32 is attached, and a connection wall 63 that connects the first supporting portion 61 and the second supporting portion 62 to each other. Since the configuration of the first supporting portion 61 and the configuration of the second supporting portion 62 are the same as each other, the configuration of the first supporting portion 61 will be described in the following description and the configuration of the second supporting portion 62, which is the same as the configuration of the first supporting portion 61, is given the same reference numeral and detailed description thereof will be omitted.

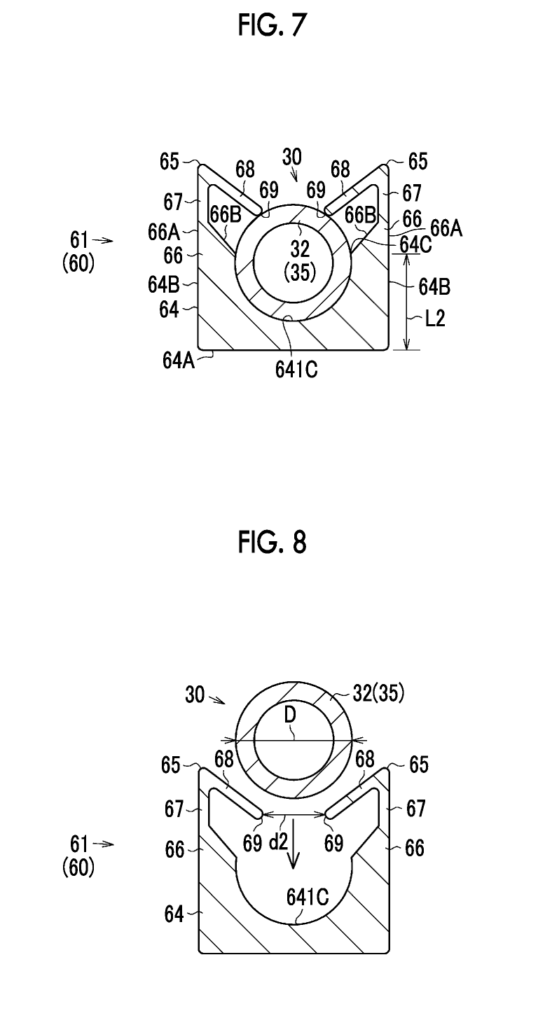

As illustrated in FIG. 7, the first supporting portion 61 includes a facing wall 64 that faces the second pipe 32 in the vehicle front-rear direction (vertical direction in FIG. 7). The facing wall 64 is formed to have an approximately rectangular section that is elongated in a vehicle width direction (right-left direction in FIG. 7) and includes a rear wall surface 64A, a pair of side wall surfaces 64B, and a front wall surface 64C. The rear wall surface 64A is disposed on the vehicle rear side (lower side in FIG. 7), the side wall surfaces 64B extend to the vehicle front side from opposite end portions of the rear wall surface 64A in the vehicle width direction, and the front wall surface 64C connects the side wall surfaces 64B. A semi-circular recess 641C of which the diameter is the same as the outer diameter of the second pipe 32 is formed on the front wall surface 64C. A pair of retaining walls 65 that protrudes to the vehicle front side from opposite end portions of the facing wall 64 is connected to the facing wall 64. Each retaining wall 65 includes a protruding wall 66 that protrudes from the front wall surface 64C of the facing wall 64 and that extends toward a side portion of the second pipe 32. Each protruding wall 66 includes an extending surface 66A that extends in the same direction as the side wall surfaces 64B of the facing wall 64 and an inclined surface 66B that extends from the inner circumferential surface of each protruding wall 66 that constitutes the recess 641C. The inclined surfaces 66B extend while being inclined with respect to the vehicle front-rear direction to become closer to the extending surfaces 66A toward the vehicle front side. Therefore, the section of each protruding wall 66 has a right-angled triangular shape that becomes narrower toward an end side. A frontward extending wall 67 that extends toward the vehicle front side is connected to the end of each protruding wall 66. The distance between the protruding walls 66 of the retaining walls 65 and the distance between the frontward extending walls 67 are longer than the outer diameter of the second pipe 32.

In addition, the retaining walls 65 are connected to the ends of the frontward extending walls 67 and are provided with returning walls 68 that extend toward the second pipe 32 side, that is, the vehicle rear side. The returning walls 68 extend while being inclined with respect to the vehicle front-rear direction such that the returning walls 68 become closer to each other toward the end side. As illustrated in FIG. 7, in a state where the second pipe 32 is disposed in the recess 641C and abuts onto the facing wall 64, end portions 69 of the returning walls 68 abut onto a portion of the second pipe 32 that is on a side opposite to the facing wall 64 side, that is, one half of the circumferential portion of the second pipe 32 that is on the vehicle front side. The end portions 69 of the returning walls 68 are an example of an abutting portion. The distance between the end portions 69 of the returning walls 68 is shorter than the outer diameter of the second pipe 32. As described above, each retaining wall 65 extends to the vehicle front side from the facing wall 64 and has a shape that is folded back to the vehicle rear side at an end portion on the vehicle front side.

A description on the way in which the second pipe 32 is attached to the first supporting portion 61 will be given. As illustrated in FIG. 8, the tubular portion 35C of the end portion 35 of the second pipe 32 is attached to the first supporting portion 61 from the vehicle front side. Before the second pipe 32 is attached, the distance d2 between the end portions 69 of the retaining walls 65 of the first supporting portion 61 is shorter than the outer diameter D of the second pipe 32. When the second pipe 32 is pressed against a space between the retaining walls 65 as represented with an arrow in FIG. 8 in this state, the retaining walls 65 are elastically deformed.

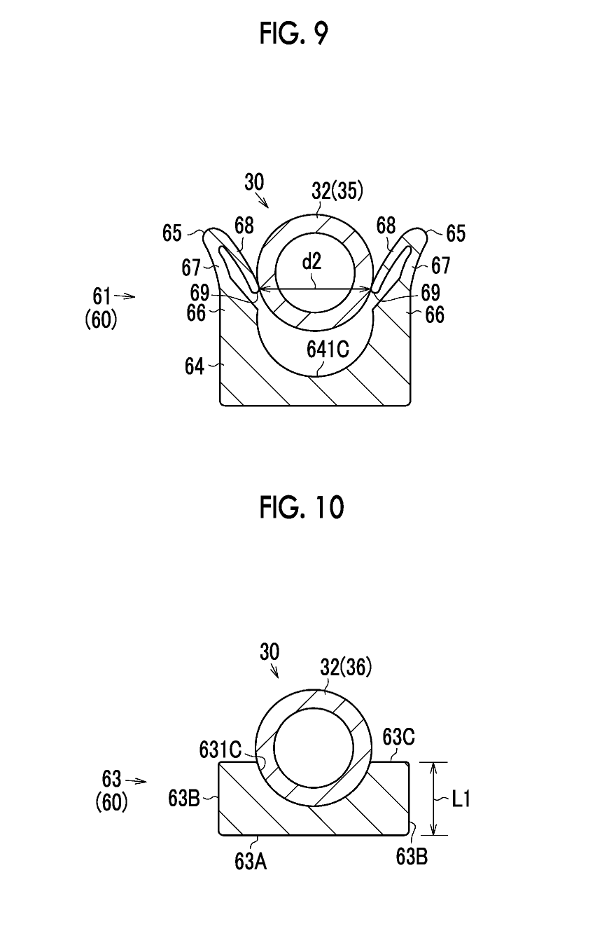

In this case, as illustrated in FIG. 9, the retaining walls 65 are elastically deformed such that the ends of the returning walls 68 become close to the protruding walls 66 respectively and the frontward extending walls 67 are separated from each other. Accordingly, the distance d2 between the end portions 69 of the retaining walls 65 increases and the second pipe 32 moves toward the facing wall 64 side. In addition, when the second pipe 32 is further pressed in this state, the second pipe 32 passes through a space between the end portions 69 of the retaining walls 65 and the second pipe 32 is disposed in the recess 641C of the facing wall 64 as illustrated in FIG. 7. When the second pipe 32 passes through the space between the end portions 69 of the returning walls 68, the retaining walls 65 returns to the original state from the elastically deformed state. Accordingly, the distance d2 between the ends of the returning walls 68 becomes shorter than the outer diameter D of the second pipe 32. As a result, the second pipe 32 is held in a state of being attached to the first supporting portion 61. Note that, when the base end portion 36 of the second pipe 32 is attached to the second supporting portion 62, as with the above description, the base end portion 36 may be pressed against a space between the retaining walls 65 of the second supporting portion 62.

As illustrated in FIG. 6, the connection wall 63 is connected to the facing wall 64 of the first supporting portion 61 and the facing wall 64 of the second supporting portion 62.

Therefore, the connection wall 63 is disposed behind the second pipe 32 in the vehicle front-rear direction. The connection wall 63 is formed into a plate-shape that is curved toward the vehicle rear side such that the connection wall 63 becomes closer to the vehicle rear side toward the vehicle upper side.

As illustrated in FIG. 10, the connection wall 63 is formed to have an approximately rectangular section that is elongated in the vehicle width direction (right-left direction in FIG. 10) and includes a rear wall surface 63A, a pair of side wall surfaces 63B, and a front wall surface 63C. The rear wall surface 63A is disposed on the vehicle rear side (lower side in FIG. 10), the side wall surfaces 63B extend to the vehicle front side from opposite end portions of the rear wall surface 63A in the vehicle width direction, and the front wall surface 63C connects the side wall surfaces 63B. The front wall surface 63C is a wall surface on the second pipe 32 side that is disposed on the vehicle front side. A recess 631C on which the second pipe 32 is disposed is formed on the front wall surface 63C. The recess 631C is formed to have the same curved shape as the outer shape of the second pipe 32. The recess 631C is formed to continue from an end portion of the connection wall 63 that is on the first supporting portion 61 side and an end portion of the connection wall 63 that is on the second supporting portion 62 side in the vehicle height direction. An end portion of the recess 631C that is on the first supporting portion 61 side is connected to the recess 641C of the first supporting portion 61 and an end portion of the recess 631C that is on the second supporting portion 62 side is connected to the recess 641C of the second supporting portion 62. Therefore, the inner circumferential surface of the recess 631C is flush with the inner circumferential surfaces of the recess 641C of the first supporting portion 61 and the recess 641C of the second supporting portion 62. The length L1 of each side wall surface 63B of the connection wall 63 in the vehicle front-rear direction is shorter than the length L2 of each side wall surface 64B of the facing wall 64 illustrated in FIG. 7 in the vehicle front-rear direction. In a state where the second pipe 32 is attached to the first supporting portion 61 and the second supporting portion 62, as illustrated in FIG. 10, a portion of the outer circumferential surface of the end portion 35 of the second pipe 32 that is on the vehicle rear side is in contact with the recess 631C of the connection wall 63.

As illustrated in FIG. 6, the fixation portion 80 includes a fixation piece portion 81 that is connected to the second supporting portion 62. The fixation piece portion 81 is configured of an abutting wall 82 that abuts onto the facing wall 64 of the second supporting portion 62 and a curved wall 83 that extends from the abutting wall 82 to the vehicle rear side while being curved. A through-hole 82A is formed in the abutting wall 82. The abutting wall 82 is connected to a supporting wall 84. The supporting wall 84 extends in the vehicle height direction. A first side wall 85 that extends toward the vehicle rear side is connected to the upper end of the supporting wall 84. The first side wall 85 extends while being inclined such that the position of the first side wall 85 becomes higher toward the vehicle rear side. A first flange 86 that extends to the vehicle upper side is connected to the rear end of the first side wall 85. The first flange 86 is fixed to a front surface of the upward extending portion 13B of the dash panel 13. In addition, a second side wall 87 that extends to the vehicle rear side is connected to the lower end of the supporting wall 84. The second side wall 87 extends while being inclined such that the position of the second side wall 87 becomes lower toward the vehicle rear side. A second flange 88 that extends toward a vehicle lower side is connected to the rear end of the second side wall 87. The second flange 88 is fixed to the front surface of the upward extending portion 13B of the dash panel 13.

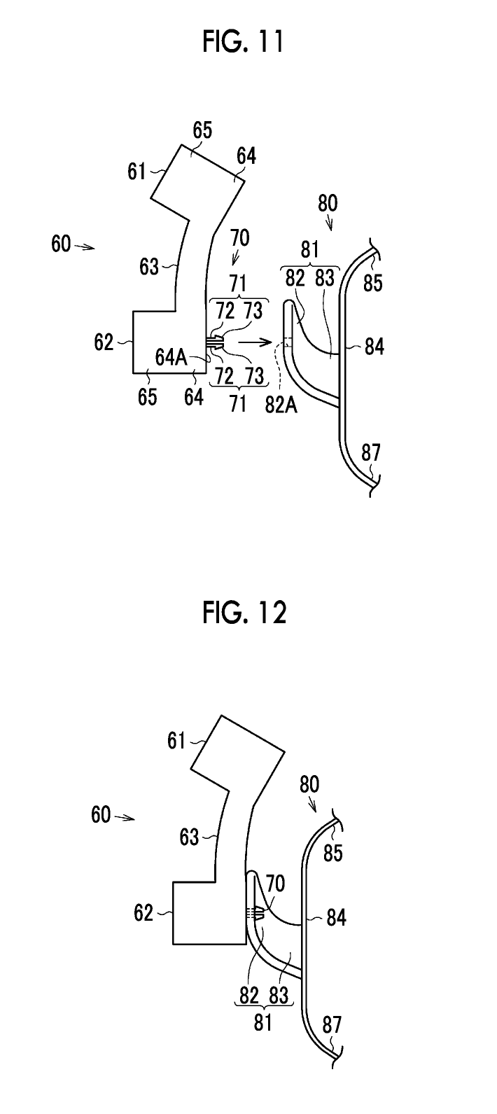

As illustrated in FIG. 11, the second supporting portion 62 is provided with a pin 70 that extends toward the vehicle rear side (right side in FIG. 11) from the rear wall surface 64A of the facing wall 64. The pin 70 is configured of a pair of separated pins 71. The separated pins 71 are separated from each other in the vehicle height direction. Each separated pin 71 is configured of a shaft portion 72 that protrudes from the rear wall surface 64A and a head portion 73 that is connected to the shaft portion 72. One of the separated pins 71 that is disposed closer to the vehicle upper side (upper side in FIG. 11) has a hook-shape with the head portion 73 extending to become closer to the vehicle upper side toward the shaft portion 72 side and a level difference being provided between the shaft portion 72 and the head portion 73. In addition, the other of the separated pins 71 that is disposed closer to the vehicle lower side (lower side in FIG. 11) has a hook-shape with the head portion 73 extending to become closer to the vehicle lower side toward the shaft portion 72 side and a level difference being provided between the shaft portion 72 and the head portion 73.

As illustrated in FIG. 12, the supporting clamp 60 is connected to the fixation portion 80 with the pin 70 of the second supporting portion 62 being inserted into the through-hole 82A of the abutting wall 82 and locked. In this manner, the first supporting portion 61 and the second supporting portion 62 of the supporting clamp 60 are fixed to the vehicle.

As illustrated in FIG. 1, the fuel pipe 25 is routed from the internal combustion engine 16 to a position below the dash panel 13 and the fuel pipe 25 extends toward the vehicle rear side up to the fuel tank 12 along a lower surface of the floor panel 11. A plurality of clamps (not shown) is connected to the lower surface of the floor panel 11 and the fuel supply pipe 50 and the purge pipe 30 are supported on the lower surface of the floor panel 11 via the clamps.

The effect of the embodiment will be described. (1) Vibration of the internal combustion engine 16 is transmitted to the second pipe 32 via the first pipe 31. When the second pipe 32 oscillates due to the vibration of the internal combustion engine 16, the magnitude of vibration of the first pipe 31 also increases. In the embodiment, the end portion 35 of the second pipe 32 that is on the first pipe 31 side is supported by the first supporting portion 61. Accordingly, even when the vibration of the internal combustion engine 16 is transmitted, oscillation of the second pipe 32 on the first pipe 31 side is more appropriately suppressed. Therefore, an increase in magnitude of the vibration of the first pipe 31 that occurs when the vibration of the internal combustion engine 16 is transmitted is more appropriately suppressed and thus it is possible to further suppress vibration of the purge pipe 30. As a result, it is possible to more appropriately suppress interference between the fuel supply pipe 50 disposed in the vicinity of the purge pipe 30 and the purge pipe 30 or interference between a member other than the fuel supply pipe 50 and the purge pipe 30.

(2) The end portion 35 of the second pipe 32 is supported by the first supporting portion 61 and the base end portion 36 of the second pipe 32 is supported by the second supporting portion 62. Therefore, it is possible to support both of the end portion 35 and the base end portion 36 of the second pipe 32. Accordingly, it is possible to further improve the supporting properties with respect to the second pipe 32. In addition, the first supporting portion 61 and the second supporting portion 62 are connected to each other by the connection wall 63. Therefore, it is possible to commonize connection between the first supporting portion 61, the second supporting portion 62, and the fixation portion 80 when disposing the supporting portions 61, 62 in order to further improve the supporting properties. In the embodiment, the first supporting portion 61 and the second supporting portion 62 are fixed to the vehicle via one fixation portion 80, which results in contribution to a decrease in number of components.

(3) In the embodiment, the second supporting portion 62 that supports the base end portion 36 of the second pipe 32 is connected to the fixation portion 80 such that the supporting clamp 60 is fixed to the vehicle via the fixation portion 80. Therefore, it is not needed to provide a fixation portion that is connected to the first supporting portion 61 and thus a space in the vicinity of the first supporting portion 61 that supports the end portion 35 of the second pipe 32 is not occupied by the fixation portion 80. Accordingly, it is possible to more appropriately restrain the space in the vicinity of the first supporting portion 61 from becoming narrow. Therefore, it is possible to further improve the assembling workability of the second pipe 32 with respect to the first supporting portion 61.

(4) The recess 631C with which the second pipe 32 comes into contact is formed on the front wall surface 63C of the connection wall 63 that is on the second pipe 32 side. When the second pipe 32 comes into contact with the recess 631C, oscillation of the second pipe 32 between the first supporting portion 61 and the second supporting portion 62 is restricted and thus it is possible to more appropriately suppress vibration of the second pipe 32.

(5) Each of the first supporting portion 61 and the second supporting portion 62 includes the facing wall 64 that faces the second pipe 32 and the retaining walls 65 that protrude from the opposite end portions of the facing wall 64. In addition, the second pipe 32 is pressed to reach the facing wall 64 with the retaining walls 65 being elastically deformed and the space between the end portions 69 of the retaining walls 65 being expanded such that the second pipe 32 is attached to the supporting portions 61, 62. In the embodiment, since the connection wall 63 is connected to the facing wall 64 of each of the first supporting portion 61 and the second supporting portion 62, the connection wall 63 is not likely to inhibit elastic deformation of each retaining wall 65 and thus it is possible to more appropriately suppress deterioration in assembling property of the second pipe 32 with respect to the supporting portions 61, 62 that is caused by the connection to the connection wall 63.

(6) Vibration transmitted from the internal combustion engine 16 to the purge pipe 30 may cause vibration of the purge pipe 30 in the vehicle front-rear direction. In the embodiment, since the connection wall 63 of the supporting clamp 60 abuts onto a portion of the second pipe 32 that is on the vehicle rear side, it is possible to more suitably suppress the vibration of the second pipe 32 in the vehicle front-rear direction.

The embodiment may be modified as follows. The following modification examples may be appropriately combined with each other. The supporting clamp 60 is disposed such that the second pipe 32 is attached to the supporting clamp 60 from the vehicle front side. That is, the supporting clamp 60 is disposed such that the facing wall 64 is disposed on the vehicle rear side and the retaining walls 65 of the first supporting portion 61 and the second supporting portion 62 protrude to the vehicle front side from the facing wall 64. The disposition of the supporting clamp 60 is not limited to that in the embodiment. For example, the supporting clamp 60 may be disposed in a state of being rotated 90° in a counter-clockwise direction with the vehicle height direction as the central axis in the state illustrated in FIG. 6 of the embodiment and the second pipe 32 may be attached to the supporting clamp 60 from the left side in the vehicle width direction.

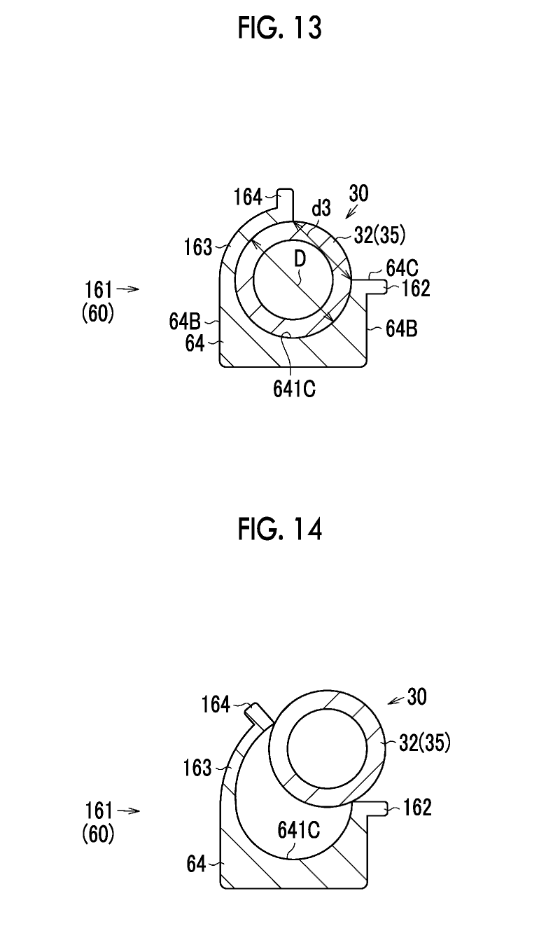

The configurations of the first supporting portion 61 and the second supporting portion 62 are not limited to the above-described configurations as long as the second pipe 32 can be held. For example, the following configuration may be adopted. As illustrated in FIG. 13, a first supporting portion 161 includes the facing wall 64 that faces the second pipe 32 in the vehicle front-rear direction. The facing wall 64 is formed to have an approximately rectangular section that is elongated in the vehicle width direction (right-left direction in FIG. 13). The semi-circular recess 641C of which the diameter is the same as the outer diameter D of the second pipe 32 is formed on the front wall surface 64C of the facing wall 64. A first protruding wall 162 that protrudes laterally from the side wall surface 64B (right surface in FIG. 13) that is on the right side in the vehicle width direction is connected to the facing wall 64. The first protruding wall 162 is connected to a front end portion of the facing wall 64. In addition, a retaining wall 163 that extends to the vehicle front side (upper side in FIG. 13) from a left end portion of the front wall surface 64C in the vehicle width direction is connected to the front wall surface 64C of the facing wall 64. The retaining wall 163 is formed to have an arc-shape that is curved around a left portion (left side in FIG. 13) of the second pipe 32 in the vehicle width direction and that extends to the right side. An end of the retaining wall 163 extends up to a front end portion of the second pipe 32. A second protruding wall 164 that extends toward the vehicle front side is connected to the end portion of the retaining wall 163.

The second pipe 32 is attached to the first supporting portion 161 as described above in the following manner. As illustrated in FIG. 14, the second pipe 32 is attached to the first supporting portion 161 through a space between the first protruding wall 162 and the second protruding wall 164. Since the distance (distance d3 in FIG. 13) between the first protruding wall 162 and the second protruding wall 164 is shorter than the outer diameter D of the second pipe 32 before the second pipe 32 is attached to the first supporting portion 161, the second protruding wall 164 is pressed such that the retaining wall 163 is elastically deformed and the distance between the first protruding wall 162 and the second protruding wall 164 increases. When the second pipe 32 is pressed in this state, the second pipe 32 passes through the space between the first protruding wall 162 and the second protruding wall 164 and the second pipe 32 is disposed in the recess 641C of the facing wall 64 as illustrated in FIG. 13. When the second pipe 32 passes through the space between the first protruding wall 162 and the second protruding wall 164, the retaining wall 163 returns to the original state from the elastically deformed state. Accordingly, the distance d3 between first protruding wall 162 and the second protruding wall 164 becomes shorter than the outer diameter D of the second pipe 32. As a result, the second pipe 32 is held in a state of being attached to the first supporting portion 161. Note that, the above-described configuration may be applied to the second supporting portion 62 in addition to the first supporting portion 61 or instead of the first supporting portion 61.

In addition, the second pipe 32 may be attached to the first supporting portion 61 or the second supporting portion 62 in a state of being separated from the facing wall 64. For example, the second pipe 32 may be supported by the retaining walls 65 while being interposed between the retaining walls 65 such that the second pipe 32 does not abut onto the facing wall 64.

In the embodiment, the recess 641C is formed on the facing wall 64 of each of the first supporting portion 61 and the second supporting portion 62. However, the recess 641C of at least one of the facing walls 64 may be omitted. The way in which the connection wall 63, the first supporting portion 61, and the second supporting portion 62 are connected can be appropriately modified. For example, the connection wall 63 may be connected to one retaining wall 65 of each of the first supporting portion 61 and the second supporting portion 62.

The configuration of the connection wall 63 can be appropriately modified. For example, the recess 631C may be formed to intermittently extend from the end portion on the first supporting portion 61 side to the end portion on the second supporting portion 62 side and may be partially formed between the end portion on the first supporting portion 61 side and the end portion on the second supporting portion 62 side. In addition, the recess 631C can be omitted.

An example in which the second supporting portion 62 is connected to the fixation portion 80 has been described. However, the way in which the first supporting portion 61, the second supporting portion 62, and the fixation portion 80 are connected can be appropriately modified. For example, the first supporting portion 61 may be connected to the fixation portion 80 and both of the first supporting portion 61 and the second supporting portion 62 may be connected to the fixation portion 80.

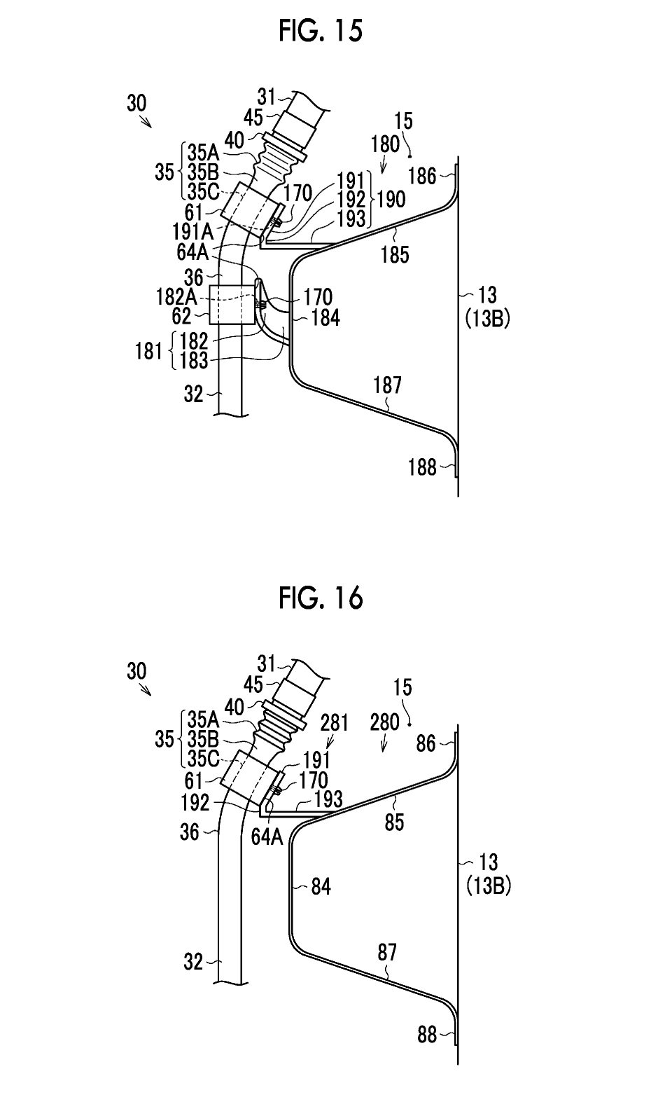

The connection wall 63 can be omitted. In this case, it is possible to adopt a configuration illustrated in FIG. 15. As illustrated in FIG. 15, the end portion 35 of the second pipe 32 is attached to the first supporting portion 61 and the base end portion 36 of the second pipe 32 is attached to the second supporting portion 62. The first supporting portion 61 is provided with a pin 170 that extends toward the vehicle rear side (right side in FIG. 15) from the rear wall surface 64A of the facing wall 64. In addition, the second supporting portion 62 is also provided with the pin 170 that extends toward the vehicle rear side from the rear wall surface 64A of the facing wall 64. Each pin 170 has the same configuration as the pin 70 described in the embodiment.

The fixation portion 180 includes a first fixation piece portion 181 that is connected to the second supporting portion 62. The first fixation piece portion 181 is configured of an abutting wall 182 that abuts onto the facing wall 64 of the second supporting portion 62 and a curved wall 183 that extends from the abutting wall 182 to the vehicle rear side while being curved. A through-hole 182A is formed in the abutting wall 182. The second supporting portion 62 is connected to the abutting wall 182 with the pin 170 inserted into the through-hole 182A. The abutting wall 182 is connected to a supporting wall 184.

The supporting wall 184 extends in the vehicle height direction. A first side wall 185 that extends toward the vehicle rear side is connected to the upper end of the supporting wall 184. The first side wall 185 extends while being inclined such that the position of the first side wall 185 becomes higher toward the vehicle rear side. A first flange 186 that extends to the vehicle upper side is connected to the rear end of the first side wall 185. The first flange 186 is fixed to the front surface of the upward extending portion 13B of the dash panel 13. In addition, a second side wall 187 that extends to the vehicle rear side is connected to the lower end of the supporting wall 184. The second side wall 187 extends while being inclined such that the position of the second side wall 187 becomes lower toward the vehicle rear side. A second flange 188 that extends toward the vehicle lower side is connected to the rear end of the second side wall 187. The second flange 188 is fixed to the front surface of the upward extending portion 13B of the dash panel 13.

The fixation portion 180 also includes a second fixation piece portion 190 that is connected to the first supporting portion 61. The second fixation piece portion 190 is configured of an inclined wall 191 that abuts onto the facing wall 64 of the first supporting portion 61, a downward extending wall 192 that extends downwards from the lower end of the inclined wall 191, and a rearward extending wall 193 that extends to the vehicle rear side from the lower end of the downward extending wall 192. A through-hole 191A is formed in the inclined wall 191. The first supporting portion 61 is connected to the inclined wall 191 with the pin 170 being inserted into the through-hole 191A. The rearward extending wall 193 is connected to the first side wall 185. As described above, in the configuration illustrated in FIG. 15, both of the first supporting portion 61 and the second supporting portion 62 are supported by the fixation portion 180 formed to have a bifurcating shape.

In addition, the first fixation piece portion 181 can be connected to the dash panel 13 with the first fixation piece portion 181 extending up to the dash panel 13 and the second fixation piece portion 190 can be connected to the dash panel 13 with the second fixation piece portion 190 extending up to the dash panel 13. In this case, the supporting wall 184, the first side wall 185, the first flange 186, the second side wall 187, and the second flange 188 of the fixation portion 180 can be omitted and each of the first fixation piece portion 181 and the second fixation piece portion 190 functions as an individual fixation portion.

In the fuel pipe structure, the second supporting portion 62 can be omitted. As such a configuration, for example, a configuration illustrated in FIG. 16 can be adopted. As illustrated in FIG. 16, the end portion 35 of the second pipe 32 is attached to the first supporting portion 61. The first supporting portion 61 includes the pin 170 that extends toward the vehicle rear side (right side in FIG. 16) from the rear wall surface 64A of the facing wall 64.

A fixation portion 280 includes the supporting wall 84, the first side wall 85, the first flange 86, the second side wall 87, and the second flange 88. In addition, the fixation portion 280 includes a fixation piece portion 281 that is connected to the first supporting portion 61. The configuration of the fixation piece portion 281 is the same as the configuration of the second fixation piece portion 190. A rearward extending wall 193 of the fixation piece portion 281 is connected to the first side wall 85 of the fixation portion 280. In the above-described configuration, in the engine compartment 15, the base end portion 36 of the second pipe 32 is not supported and the end portion 35 of the second pipe 32 is supported. In the first place, in the fuel pipe structure, it is possible to support the base end portion 36 of the second pipe 32 in the engine compartment 15 at a plurality of positions by connecting a plurality of supporting members supporting the base end portion 36 of the second pipe 32 to the dash panel 13.

An example in which connection between the first supporting portion 61 and the fixation portions 80, 180, 280 and connection between the second supporting portion 62 and the fixation portions 80, 180, 280 are performed via the pins 70, 170 have been described as an example. However, the way in which those elements are connected can be appropriately modified. For example, the supporting portions 61, 62 may be connected to the fixation portions 80, 180, 280 by means of bonding, deposition, welding, and bolting.

A portion of the end portion 35 of the second pipe 32 via which the second pipe 32 is attached to the first supporting portion 61 is not limited to the tubular portion 35C and may be the tapered portion 35B or the wave-shaped portion 35A, for example. In addition, the end portion 35 of the second pipe 32 may be attached to the first supporting portion 61 such that the first supporting portion 61 extends over two or more of the tubular portion 35C, the tapered portion 35B, and the wave-shaped portion 35A. In addition, when a portion of the second pipe 32 including the end portion 35 is attached to the first supporting portion 61, it is also possible to assemble a portion of the second pipe 32 extending over the base end portion 36 with the first supporting portion 61.

The base end portion 36 of the second pipe 32 is attached to the second supporting portion 62. When a portion of the second pipe 32 including the base end portion 36 is attached to the second supporting portion 62, it is also possible to assemble a portion of the second pipe 32 extending over the end portion 35 with the second supporting portion 62. In this case, the second supporting portion 62 that is disposed below the first supporting portion 61 supports the base end portion 36 of the second pipe 32 and supports the end portion 35 of the second pipe 32, also.

The configuration of the second pipe 32 is not limited to that in the embodiment. For example, as the constituent material of the second pipe 32, non-thermosetting resin, metal or the like may be adopted instead of the thermosetting resin.

The configuration of the first pipe 31 is not limited to that in the embodiment. For example, as the constituent material of the first pipe 31, resin, metal or the like may be adopted instead of the rubber. The configuration of the connection pipe 40 is not limited to that in the embodiment. For example, the second internal pipe portion 42 may be configured to have a cylindrical shape with a uniform diameter as with the first internal pipe portion 41 and the first internal pipe portion 41 may be configured to have a tapered shape with the outer surface thereof having a wave-shape as with the second internal pipe portion 42. In a case where the second internal pipe portion 42 is configured to have a cylindrical shape with a uniform diameter as with the first internal pipe portion 41, it is desirable that the annular clamping tool 45 is provided on the outer circumferential surface of the second pipe 32 such that the outer circumferential side of the second pipe 32 is clamped and separation of the second internal pipe portion 42 from the second pipe 32 is further suppressed. In addition, the constituent material of the connection pipe 40 is not limited to resin and may be metal or the like.

In the embodiment, a supporting structure supporting the purge pipe 30 as a fuel pipe has been described as an example. However, the same configuration can be applied to a supporting structure that supports the fuel supply pipe 50.

What is claimed is:

1. A fuel pipe structure comprising:
a fuel pipe through which fuel is supplied from a fuel tank to an internal combustion engine, the fuel pipe including a first pipe connected to the internal combustion engine and a second pipe connected to the first pipe;
a supporting portion to which the second pipe is attached; and
a fixation portion configured to fix the supporting portion to a vehicle,
wherein an end portion of the second pipe, the end portion being on the first pipe side, is attached to the supporting portion.

2. The fuel pipe structure according to claim 1, wherein:
the second pipe includes a base end portion that is connected to the end portion and that is positioned closer to the fuel tank side than the end portion; and
the supporting portion includes a first supporting portion to which the end portion of the second pipe is attached, a second supporting portion to which the base end portion of the second pipe is attached, and a connection wall that connects the first supporting portion and the second supporting portion to each other.

3. The fuel pipe structure according to claim 1, wherein:
the second pipe includes a base end portion that is connected to the end portion and that is positioned closer to the fuel tank side than the end portion; and
the supporting portion includes a first supporting portion to which the end portion of the second pipe is attached.

4. The fuel pipe structure according to claim 3, wherein the fixation portion is connected to the first supporting portion.

5. The fuel pipe structure according to claim 3, wherein the supporting portion further includes a second supporting portion to which the base end portion of the second pipe is attached.

6. The fuel pipe structure according to claim 5, wherein the fixation portion is connected to the first supporting portion and the second supporting portion.

7. The fuel pipe structure according to claim 2, wherein the fixation portion is connected to the second supporting portion.

8. The fuel pipe structure according to claim 2, wherein the connection wall includes a recess provided on a wall surface of the connection wall that is on the second pipe side, and the recess comes into contact with the second pipe.

9. The fuel pipe structure according to claim 2, wherein:
each of the first supporting portion and the second supporting portion includes a facing wall that faces the second pipe and a pair of retaining walls that protrudes from opposite end portions of the facing wall, each of the retaining walls including an abutting portion that abuts onto one half of a circumferential portion of the second pipe that is on a side opposite to the facing wall side in a state where the second pipe abuts onto the facing wall; and
the connection wall is connected to the facing wall of the first supporting portion and the facing wall of the second supporting portion.

10. The fuel pipe structure according to claim 1, further comprising a connection pipe configured to connect an upstream side end of the first pipe and a downstream side end of the second pipe to each other.

11. The fuel pipe structure according to claim 10, wherein:
the connection pipe includes a first internal pipe portion that is inserted into the first pipe, a second internal pipe portion that is inserted into the second pipe, and a stopping pipe portion that is disposed between the first internal pipe portion and the second internal pipe portion; and
an outer diameter of the stopping pipe portion is larger than an outer diameter of the first internal pipe portion and an outer diameter of the second internal pipe portion, the stopping pipe portion including a downstream side surface onto which the upstream side end of the first pipe abuts and an upstream side surface onto which the downstream side end of the second pipe abuts.

12. The fuel pipe structure according to claim 9, wherein the facing wall of the supporting portion includes a recess that accommodates a portion of the second pipe and onto which the second pipe abuts.
